(19) United States
(12) Patent Application Publication
(10) Pub. No.: US 2014/0093342 A1
(43) Pub. Date: Apr. 3, 2014

(54) TRAILER LOADING RAMP

(71) Applicant: SONOCO DEVELOPMENT INCORPORATED, Hartsville, SC (US)

(72) Inventor: Jeff King, King, NC (US)

(73) Assignee: Sonoco Development Incorporated, Hartsville, SC (US)

(21) Appl. No.: 13/633,186

(22) Filed: Oct. 2, 2012

(51) Int. Cl. B60P 1/43

(52) U.S. Cl. CPC B60P 1/43
USPC 414/523

(57) ABSTRACT

The present invention relates to a trailer loading ramp with a trailer ramp platform and a ramp platform that may include hydraulic cylinders to move between loading and hauling positions. The trailer ramp platform and ramp platform may allow for ease of loading by providing access from the ground surface when the trailer loading ramp is in the loading position and may retract to avoid the ground when in the hauling position.

### FIELD OF THE INVENTION

The present invention relates generally to ramps that may be utilized in connection with trailers. More particularly, the present invention relates to a trailer loading ramp that can be utilized for aiding in the collection and deposit of material onto a trailer bed.

### BACKGROUND OF THE INVENTION

Motor vehicle trailers and trailer ramps have been, and continue to be utilized in a number of applications. In some instances, the trailer ramps may provide access to areas of the trailer with the use of a motor vehicle. Efforts have been made to adapt motor vehicle trailers to particular applications using a variety of trailer loading ramps.

### SUMMARY OF THE INVENTION

According to an aspect, the present invention provides a trailer loading ramp to be adapted to a trailer comprising a trailer ramp platform comprising a first end and an opposite second end; a trailer ramp platform hydraulic cylinder connected to the trailer ramp platform first end and adapted to connect the trailer ramp platform to a body of a trailer; a ramp platform comprising a first end and an opposite second end, where the ramp platform first end is pivotally connected to the trailer ramp platform second end; and a ramp platform hydraulic cylinder connecting the trailer ramp platform to the ramp platform. Actuation of the trailer ramp platform hydraulic cylinder causes the trailer ramp platform to move between a hauling position, where the trailer ramp platform is substantially parallel with a ground surface, and a loading position, where the trailer ramp platform is at an angled orientation where the trailer ramp platform first end is elevated. In addition, actuation of the ramp platform hydraulic cylinder causes the ramp platform to move between the hauling position, where the ramp platform is substantially perpendicular to the trailer ramp platform, and the loading position, where the ramp platform is at an angled position and makes contact with a ground surface.

According to another aspect, the present invention also provides a trailer comprising a trailer body defining a first trailer end and a second trailer end; a trailer ramp platform comprising a first end and an opposite second end; a trailer ramp platform hydraulic cylinder connected to the trailer ramp platform first end and connecting the trailer ramp platform to the trailer body; a ramp platform comprising a first end and an opposite second end, where the ramp platform first end is pivotally connected to the trailer ramp platform second end; and a ramp platform hydraulic cylinder connecting the trailer ramp platform to the ramp platform. Actuation of the trailer ramp platform hydraulic cylinder causes the trailer ramp platform to move between a hauling position, where the trailer ramp platform is substantially parallel with a ground surface, and a loading position, where the trailer ramp platform is at an angled orientation where the trailer ramp platform first end is elevated. In addition, actuation of the ramp platform hydraulic cylinder causes the ramp platform to move between the hauling position, where the ramp platform is substantially perpendicular to the trailer body, and the loading position, where the ramp platform is at an angled position and makes contact with a ground surface.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a side view of a trailer having a trailer loading ramp in accordance with an embodiment of the present invention;

FIG. 2 is a cross-sectional view of the trailer loading ramp of FIG. 1 cut along line 2-2 where the trailer loading ramp is in a hauling position;

FIG. 3 is a cross-sectional view of the trailer loading ramp of FIG. 1 cut along line 2-2 where the trailer loading ramp is transitioning into a loading position;

FIG. 4 is a cross-sectional view of the trailer loading ramp of FIG. 1 cut along line 2-2 where the trailer loading ramp is continuing to transition into a loading position;

FIG. 5 is a cross-sectional view of the trailer loading ramp of FIG. 1 cut along line 2-2 where the trailer loading ramp is continuing to transition into a loading position;

FIG. 6 is a cross-sectional view of the trailer loading ramp of FIG. 1 cut along line 2-2 where the trailer loading ramp is continuing to transition into a loading position;

FIG. 7 is a cross-sectional view of the trailer loading ramp of FIG. 1 cut along line 2-2 where the trailer loading ramp is in a loading position; and

FIG. 8 is an enlarged side view of a trailer ramp platform first end and a dock plate of the trailer loading ramp of FIG. 1.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

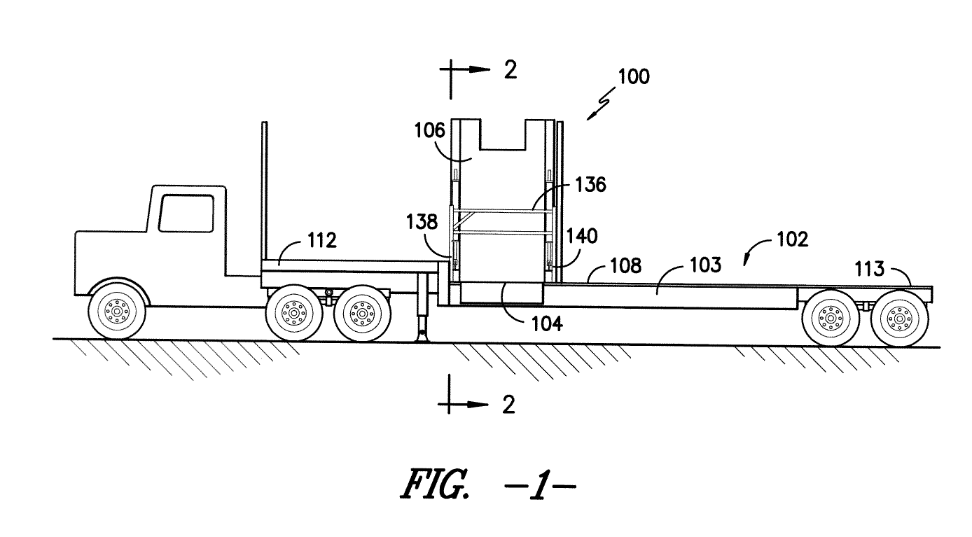

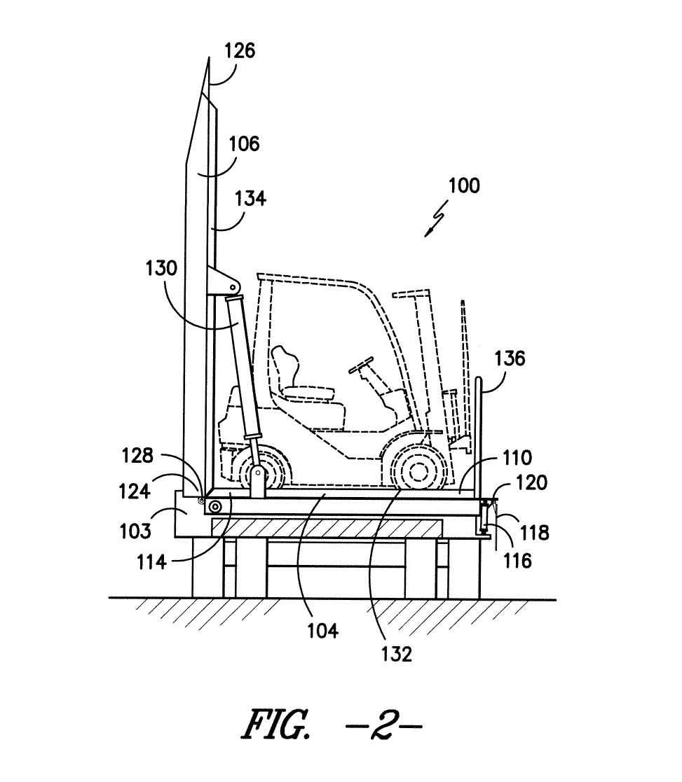

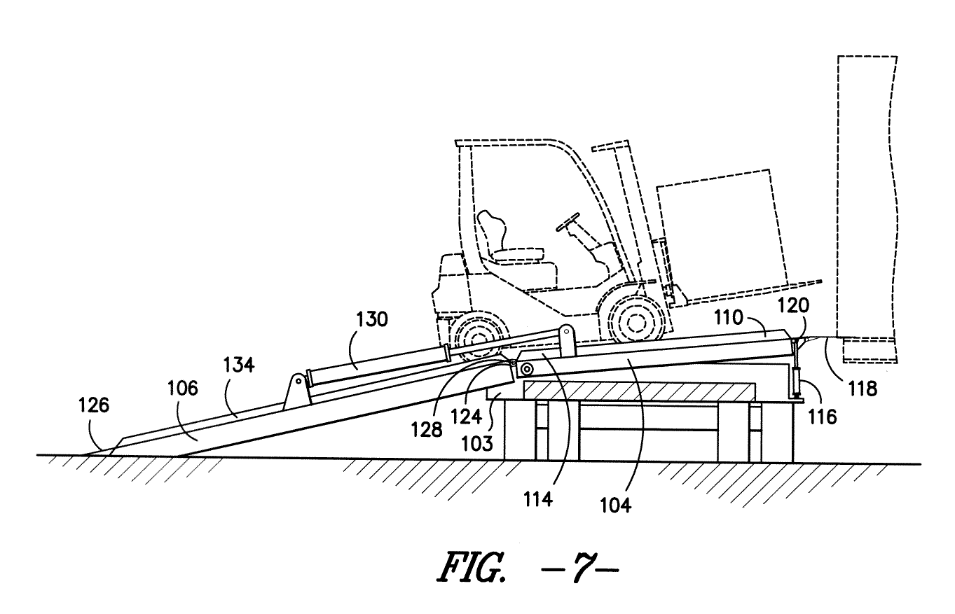

A trailer loading ramp 100 in accordance with an embodiment of the present invention is shown in the Figures. As shown in FIG. 1, trailer loading ramp 100 may be used in connection with flatbed trailers 102 that include a trailer body 103. Trailer loading ramp 100 includes a trailer ramp platform 104 and a ramp platform 106. As more fully explained below, trailer loading ramp 100 may move between a hauling position (FIG. 2) where trailer ramp platform 104 is parallel with a flatbed trailer top portion 108 and ramp platform 106 is perpendicular to flatbed trailer 102, and a loading position (FIG. 7) where trailer ramp platform 104 is elevated at a first end 110 and ramp platform 106 is at an angled position and makes contact with the ground surface. As more fully explained below, trailer loading ramp 100 may be adapted to transport a forklift truck while in the hauling position, and may aid in the assessable removal of the forklift truck and in the collection of material to be placed on flatbed trailer 102 while in the loading position.

Trailer loading ramp 100 may be positioned between a first end 112 and a second end 113 of trailer body 103. Although FIG. 1 illustrates trailer loading ramp 100 proximate first end 112, it should be understood that trailer loading ramp 100 may be situated at any position between first end 112 and second end 113 based on the specifications of the user. In addition, in some embodiments, trailer loading ramp 100 may be positioned such that trailer ramp platform 104 is situated atop flatbed trailer top portion 108. In further embodiments, however, trailer loading ramp 100 may be positioned such that trailer ramp platform 104 is integral and forms a substantially flat surface with an adjacent portion of flatbed trailer top portion.

Flatbed trailer 102 may further include a connector (not shown) located at trailer body first end 112 such that flatbed trailer may be pulled by a motor vehicle while trailer loading ramp 100 is in a hauling position. In some embodiments, connector may include a standard trailer coupler to connect to a standard trailer hitch and ball located on a motor vehicle. In other embodiments, other types of couplers utilized with tractor-trailers may be used. For example, connector may include a coupling pin to attach to a fifth wheel coupling device of a towing truck. The user's application of the trailer and the trailer loading ramp will dictate the necessary connector utilized.

As indicated above, trailer loading ramp 100 includes a trailer ramp platform 104 located on flatbed trailer top portion 108. Trailer ramp platform 104 includes the first end 110, which may be elevated, and an opposite second end 114, which is located adjacent ramp platform 106. As indicated above, trailer ramp platform first end 110 may be elevated to move trailer ramp platform 104 in a downwardly sloping orientation (loading position) toward ramp platform 106. To aid in obtaining such orientation, a trailer ramp platform hydraulic cylinder 116 may be in mechanical communication between trailer ramp platform first end and trailer body 103, such that activation of trailer ramp platform hydraulic cylinder 116 may move trailer ramp platform 104 between its hauling position and its loading position.

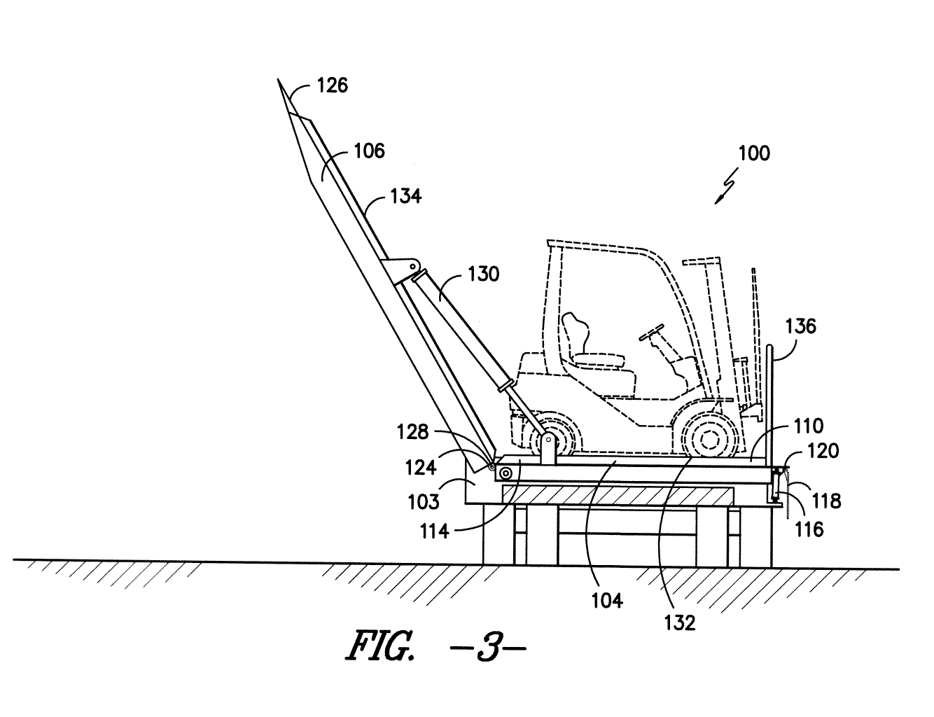

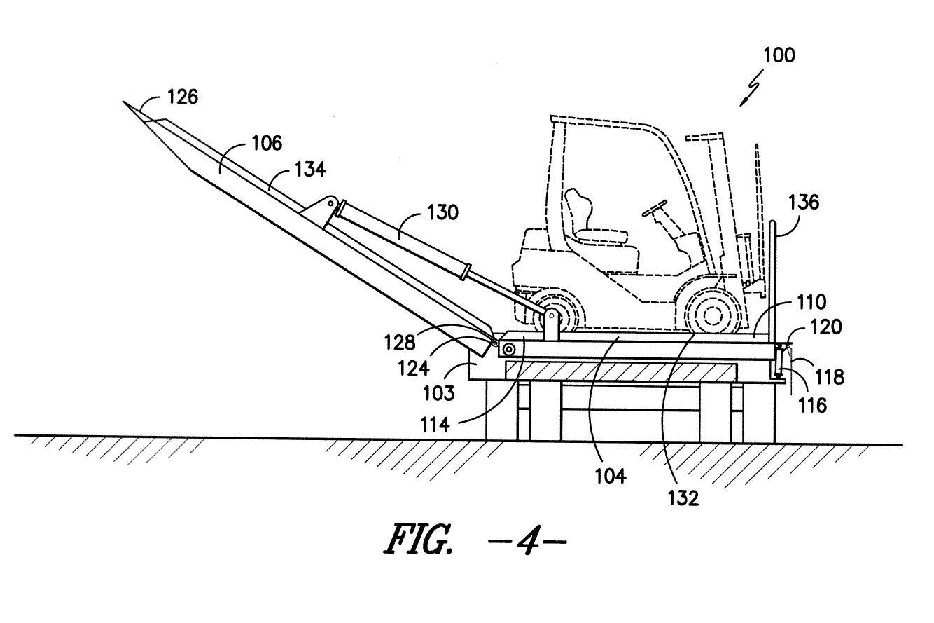

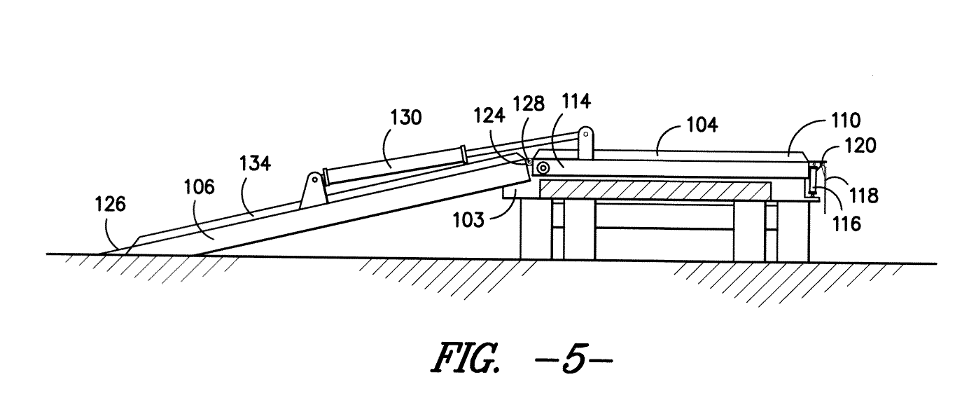

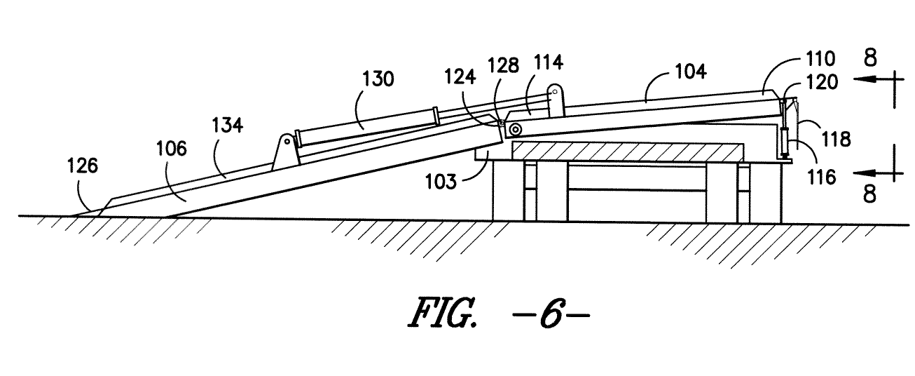

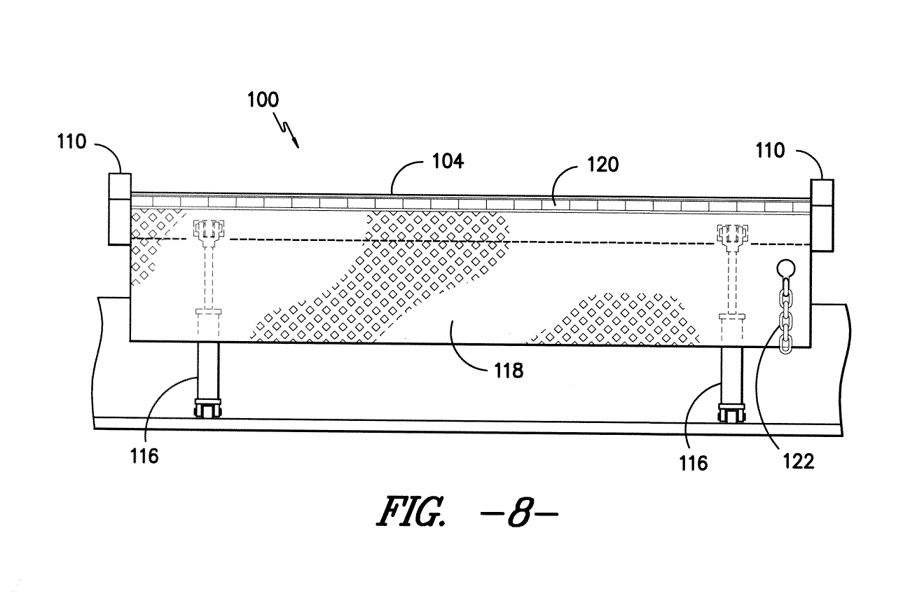

In some embodiments, trailer loading ramp 100 may further include a dock plate 118 as shown in FIGS. 2 through 7. As more fully explained below, dock plate 118 may aid in providing a continuous surface between trailer ramp platform 104 and the bed of another trailer (shown in FIG. 7). Dock plate 118 may be rotatably connected by a hinge 120 to trailer ramp platform first end 110. Such rotatable connection allows dock plate 120 to move from a position perpendicular (FIG. 2) to trailer ramp platform 104 when trailer loading ramp 100 is in a hauling position to a position that is not perpendicular (FIG. 7) to trailer ramp platform 104 when trailer loading ramp 100 is in a loading position. In some embodiments, and as shown in FIG. 8, dock plate 118 may further be connected to trailer body 103 to reduce the possible movement of dock plate 118 when it is in the hauling position. Although FIG. 8 illustrates the connection of dock plate 120 to trailer body 103 with the use of a chain 122, other connectors known in the art may also be utilized. For example, rope or other fasteners may be used.

As indicated above, trailer loading ramp 100 further includes a ramp platform 106 that moves from a hauling position, where ramp platform 106 is substantially perpendicular to trailer body 103 to a loading position, where ramp platform 106 is downwardly sloping and makes contact with the ground surface. Ramp platform 106 includes a first end 124 that is adjacent to trailer ramp platform second end 114 and a second end 126 that makes contact with the ground surface when in the loading position. To aid in such transformation, ramp platform 106 is rotatably connected on its first end 124 by a ramp platform hinge 128 to trailer ramp platform second end 114. Such rotatable connection allows for the movement of ramp platform 106 between the hauling and loading positions, as discussed above.

In addition, in some embodiments, a ramp platform hydraulic cylinder 130 may be in mechanical communication between a top portion 132 of trailer ramp platform 104 and a top potion 134 of ramp platform 106, such that activation of ramp platform hydraulic cylinder 130 may move, in connection with ramp platform hinge 128, ramp platform 106 from the hauling position to the loading position. Although the Figures illustrate ramp platform with two ramp platform hydraulic cylinders 130, it should be understood that in additional embodiments one, three, four or more cylinders may be used based on the user's specifications.

In some embodiments, trailer ramp platform and ramp platform top portions 132, 134, as well as dock plate 118 may include a non-skid and/or anti-skid surface. Such surfaces may include coatings of various non- and/or anti-skid materials, for example, paints or other coatings, or may include raised projections. Any non-skid and/or anti-skid material known in the art may be used.

As shown in FIG. 1, trailer loading ramp 100 may further include a barrier 136 at trailer ramp platform first end 110. Barrier 136 may be in the form of a gate, as shown in the Figure, or some other form known in the art to provide additional protection for ensuring the forklift does not fall off of flatbed trailer 102 while located atop trailer loading ramp 100. In some embodiments, barrier 136 may include a first end 138 and a second end 140, where first end 138 is selectively secured to trailer body 103 and second end 140 is rotatably connected to trailer body 103. Such connections allow for barrier 136 to swing in a direction towards second end 140 when a movement across and off of trailer ramp platform first end 110 is desired.

In operation, trailer loading ramp 100 may transition between a hauling position and a loading position. When trailer loading ramp is in a hauling position, flatbed trailer 102 may be pulled by a motor vehicle to a desired location. In the hauling position, the various components of the trailer loading ramp 100 are in a position such that they do not make contact with the ground surface where they would impede the transport of flatbed trailer 102. As explained above, the movement of ramp platform 106 and trailer ramp platform 104 into the loading position may be automated by the appropriate hydraulic cylinder(s) such that orienting trailer loading ramp 100 into the hauling position may be done without manual action. In additional embodiments, however, manual efforts may be utilized to replace some or all of the hydraulic cylinders

Once the trailer reaches its desired loading or unloading destination, trailer loading ramp 100 may be transitioned from the hauling position to the loading position. When trailer loading ramp 100 is in a loading position, it may be utilized, in some embodiments, to place material onto flatbed trailer 102 or to create a ramp from the ground surface to an elevated surface, for example, another tractor trailer or loading dock. To transition trailer loading ramp 100 from the hauling position to the loading position, ramp platform 106 is actuated forward by ramp platform hydraulic cylinder 130 until its second end 126 reaches the ground surface. In addition, trailer bed platform first end 110 is actuated by trailer ramp platform hydraulic cylinder 116 such that first end 110 is elevated, causing trailer bed platform 104 to be downwardly sloping between its first end and second end. Once in position, dock plate 118 may be raised to meet the surface of another trailer bed or loading dock to create a continuous surface, as explained above. In addition, if utilized, barrier 136 may be swung towards barrier second end 140 to allow movement off of trailer ramp platform 110. The transition from the hauling position to the loading position is illustrated in FIGS. 2 through 7.

The angle of the ramp platform 106 and trailer bed platform 104 while in the loading position may be such to effectively allow the user to load and unload items from the elevated surface. For example, the angle may be such that a forklift truck is able to drive onto trailer loading ramp 100 without fear of it tipping over. In some embodiments, in the loading position, ramp platform 106 and trailer bed platform 104 may be at an angle between about 6° and about 15°. In other embodiments, in the loading position, ramp platform 106 and trailer bed platform 104 may be at an angle between about 8° and about 10°.

The various embodiments of trailer loading ramp 100 illustrated and disclosed above allow for the effective and efficient collection and transport of materials. In addition, such tasks can be completed with little to no manual force on the part of the user.

As indicated above, the trailer loading ramp 100 of the present invention allows for methods of effectively and efficiently collecting and transferring material from or to the ground level to or from an elevated loading surface. Accordingly, the present invention contemplates the use of such methods. For example, the trailer loading ramp 100, in some embodiments, may be utilized to transport a forklift truck to a desired location and use that forklift truck to collect baled materials or packaged materials from the interiors of loading docks, tractor trailer beds and other elevated structures. Following the collection, the baled or packaged materials may be placed on flatbed trailer 102 such that it may be moved to a collection site or other location.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged in whole or in part. Furthermore, those of ordinary skill in the art will appreciate that the foregoing description is by way of example only, and is not intended to limit the invention so further described in such appended claims. Therefore, the spirit and scope of the appended claims should not be limited to the description of the versions contained therein.

What is claimed is:

1. A trailer loading ramp to be adapted to a trailer comprising:
a trailer ramp platform comprising a first end and an opposite second end;
a trailer ramp platform hydraulic cylinder connected to the trailer ramp platform first end and adapted to connect the trailer ramp platform to a body of a trailer;
a ramp platform comprising a first end and an opposite second end, where the ramp platform first end is pivotally connected to the trailer ramp platform second end; and
a ramp platform hydraulic cylinder connecting the trailer ramp platform to the ramp platform,
wherein actuation of the trailer ramp platform hydraulic cylinder causes the trailer ramp platform to move between a hauling position, where the trailer ramp platform is substantially parallel with a ground surface, and a loading position, where the trailer ramp platform is at an angled orientation where the trailer ramp platform first end is elevated; and
wherein actuation of the ramp platform hydraulic cylinder causes the ramp platform to move between the hauling position, where the ramp platform is substantially perpendicular to the trailer ramp platform, and the loading position, where the ramp platform is at an angled position and makes contact with a ground surface.

2. The trailer loading ramp of claim 1, wherein the ramp platform is connected to the trailer ramp platform by a hinge.

3. The trailer loading ramp of claim 1, wherein the ramp platform hydraulic cylinder is located on a top portion of the ramp platform and the trailer ramp platform.

4. The trailer loading ramp of claim 1, wherein the trailer loading ramp comprises two ramp platform hydraulic cylinders.

5. The trailer loading ramp of claim 1, wherein the trailer loading ramp comprises two trailer ramp platform hydraulic cylinders.

6. The trailer loading ramp of claim 1, wherein the ramp platform second end comprises one or more wheels.

7. The trailer loading ramp of claim 1, wherein the ramp platform and the trailer ramp platform comprise an upper surface, wherein the upper surfaces comprise a non-skid or anti-skid material.

8. The trailer loading ramp of claim 1, wherein when the ramp platform and the trailer ramp platform are in the loading position, the ramp platform and the trailer ramp platform comprise an angle between about 6° and about 15°.

9. A trailer comprising:
a trailer body defining a first trailer end and a second trailer end;
a trailer ramp platform comprising a first end and an opposite second end;
a trailer ramp platform hydraulic cylinder connected to the trailer ramp platform first end and connecting the trailer ramp platform to the trailer body;
a ramp platform comprising a first end and an opposite second end, where the ramp platform first end is pivotally connected to the trailer ramp platform second end; and
a ramp platform hydraulic cylinder connecting the trailer ramp platform to the ramp platform,
wherein actuation of the trailer ramp platform hydraulic cylinder causes the trailer ramp platform to move between a hauling position, where the trailer ramp platform is substantially parallel with a ground surface, and a loading position, where the trailer ramp platform is at an angled orientation where the trailer ramp platform first end is elevated; and
wherein actuation of the ramp platform hydraulic cylinder causes the ramp platform to move between the hauling position, where the ramp platform is substantially perpendicular to the trailer body, and the loading position, where the ramp platform is at an angled position and makes contact with a ground surface.

10. The trailer of claim 9, wherein the trailer ramp platform is placed atop a top portion of the trailer body.

11. The trailer of claim 9, wherein the trailer ramp platform is integral with a top portion of the trailer body.

12. The trailer of claim 9, wherein the ramp platform is connected to the trailer ramp platform by a hinge.

13. The trailer of claim 9, wherein the ramp platform hydraulic cylinder is located on a top portion of the ramp platform and the trailer ramp platform.

14. The trailer of claim 9, wherein the ramp platform second end comprises one or more wheels.

15. The trailer of claim 9, wherein the ramp platform and the trailer ramp platform comprise an upper surface, wherein the upper surfaces comprise a non-skid or anti-skid material.

16. The trailer of claim 9, wherein when the ramp platform and the trailer ramp platform are in the loading position, the ramp platform and the trailer ramp platform comprise an angle between about 6° and about 15°.

17. A trailer loading ramp to be adapted to a trailer comprising:
a trailer ramp platform comprising a first end and an opposite second end;
a trailer ramp platform hydraulic cylinder connected to the trailer ramp platform first end and adapted to connect trailer ramp to a body of a trailer;
a dock plate pivotally connected to the trailer ramp platform on the first end of the trailer ramp platform;
a ramp platform comprising a first end and an opposite second end, where the ramp platform first end is pivotally connected to the trailer ramp platform second end; and
a ramp platform hydraulic cylinder connecting the trailer ramp platform to the ramp platform,
wherein actuation of the trailer ramp platform hydraulic cylinder causes the trailer ramp platform to move between a hauling position, where the trailer ramp platform is substantially parallel with a ground surface, and a loading position, where the trailer ramp platform is at an angled orientation where the trailer ramp platform first end is elevated;
wherein the dock plate may move from the hauling position, where the dock plate is substantially perpendicular to the trailer ramp platform, and the loading position, where the dock plate is not substantially perpendicular to the trailer ramp platform; and
wherein actuation of the ramp platform hydraulic cylinder causes the ramp platform to move between the hauling position, where the ramp platform is substantially perpendicular to the trailer body, and the loading position, where the ramp platform is at an angled position and makes contact with a ground surface.

18. The trailer loading ramp of claim 17, wherein the trailer ramp platform is adapted to be placed atop a trailer body of a trailer.

19. The trailer loading ramp of claim 17, wherein the trailer ramp platform is adapted to be integral with a top portion of a trailer body of a trailer.

20. The trailer loading ramp of claim 17, wherein the dock plate is connected to the first end of the trailer ramp platform by a hinge.

21. The trailer loading ramp of claim 17, wherein the ramp platform, the dock plate, and the trailer ramp platform comprise an upper surface, wherein the upper surfaces comprise a non-skid or anti-skid material.

22. The trailer loading ramp of claim 17, wherein the ramp platform hydraulic cylinder is located on a top portion of the ramp platform and the trailer ramp platform.

23. The trailer loading ramp of claim 17, wherein the dock plate includes a connector that is adapted to be selectively locked to a trailer body of a trailer.
